(19) United States
(12) Patent Application Publication
(10) Pub. No.: US 2026/0222602 A1
(43) Pub. Date: Jul. 30, 2026

(54) WAVEFRONT PARALLEL PROCESSING WITH PROBABILITY UPDATES

(71) Applicant: GOOGLE LLC, Mountain View, CA (US)

(72) Inventors: Hui Su, Sunnyvale, CA (US); In Suk Chong, Mountain View, CA (US); Joseph Young, Mountain View, CA (US)

(21) Appl. No.: 19/443,206

(22) Filed: Jan. 8, 2026

Related U.S. Application Data
(60) Provisional application No. 63/751,009, filed on Jan. 29, 2025.

(51) Int. Cl. H04N 19/196; H04N 19/14; H04N 19/174; H04N 19/436

(52) U.S. Cl. CPC H04N 19/196; H04N 19/14; H04N 19/174; H04N 19/436

(57) ABSTRACT

Multiple wavefronts and multiple wavefront groups are configured for a tile of a current frame. Each wavefront group of the multiple wavefront groups comprises a set of consecutive coding unit rows. Each wavefront of the multiple wavefronts comprises coding unit rows selected at intervals across the tile such that an nth row of each of the multiple wavefront groups belongs to an nth wavefront. For each wavefront of at least some of the multiple wavefronts, a probability model is initialized for a first row of the wavefront. The probability model is updated during coding of subsequent rows of the wavefront using finishing probability values from a previous row of the wavefront.

### CROSS REFERENCE TO RELATED APPLICATION(S

This application claims the benefit of and priority to U.S. Provisional Patent Application Serial No. 63/751,009, filed January 29, 2025, the entire disclosure of which is incorporated herein by reference.

### BACKGROUND

Digital video streams may represent video using a sequence of frames or still images. Digital video can be used for various applications including, for example, video conferencing, high definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including encoding or decoding techniques.

### SUMMARY

One aspect of the disclosed implementations relates to a method that includes configuring multiple wavefronts and multiple wavefront groups for a tile of a current frame, wherein each wavefront group of the multiple wavefront groups includes a set of consecutive coding unit rows, and wherein each wavefront of the multiple wavefronts includes coding unit rows selected at intervals across the tile such that an nth row of each of the multiple wavefront groups belongs to an nth wavefront; and for each wavefront of at least some of the multiple wavefronts: initializing a probability model for a first row of the wavefront; and updating the probability model during coding of subsequent rows of the wavefront using finishing probability values from a previous row of the wavefront.

One aspect of the disclosed implementations relates to a device that includes a processor. The processor is configured to execute instructions to configure multiple wavefronts and multiple wavefront groups for a tile of a current frame, wherein each wavefront group of the multiple wavefront groups includes a set of consecutive coding unit rows, and wherein each wavefront of the multiple wavefronts includes coding unit rows selected at intervals across the tile such that an nth row of each of the multiple wavefront groups belongs to an nth wavefront; and for each wavefront of at least some of the multiple wavefronts: initialize a probability model for a first row of the wavefront; and update the probability model during coding of subsequent rows of the wavefront using finishing probability values from a previous row of the wavefront.

One aspect of the disclosed implementations relates to a non-transitory computer-readable storage medium storing an encoded bitstream for decoding by a processor. The encoded bitstream includes encoded video data corresponding to a tile of a current frame; and wavefront configuration information for the tile, the wavefront configuration information including at least one of: a number of multiple wavefronts, a wavefront size, or a processing delay between adjacent wavefronts.

These and other aspects of the present disclosure are disclosed in the following detailed description of the implementations, the appended claims and the accompanying figures.

### BRIEF DESCRIPTION OF THE DRAWINGS

The description herein makes reference to the accompanying drawings described below, wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a typical video stream to be encoded and subsequently decoded.

FIG. 4 is a block diagram of an encoder according to implementations of this disclosure.

FIG. 5 is a block diagram of a decoder according to implementations of this disclosure.

FIG. 6 illustrates an example of a tile being processed using wavefront parallel processing.

FIG. 7 illustrates examples of portions of compressed bitstreams that include wavefront configuration information.

FIG. 8 is an example illustrating probability updates with wavefront parallel processing.

FIG. 9 is an example of a flowchart of a technique for selecting initial CDFs prior to processing LCU rows of a tile and for setting final CDFs after processing all LCU rows of the tile.

FIG. 10 is an example of a flowchart of a technique for selecting initial probability models prior to processing coding unit rows of a tile and for setting final probability models after processing all coding unit rows of the tile.

### DETAILED DESCRIPTION

Video compression technologies face increasing demands as digital video content continues to grow exponentially. Modern video applications require processing of high-resolution content while maintaining both speed and compression efficiency. As video resolutions escalate and content complexity increases, video encoding systems may benefit from efficiently leveraging modern multi-core processor architectures. Traditional video compression techniques often struggle to fully utilize available computational resources, creating performance bottlenecks in video processing pipelines.

Parallelization techniques in video encoding aim to simultaneously process multiple coding units across different parts of a video frame. These techniques include tile-based processing, where different regions of a frame can be coded (encoded or decoded) independently, and wavefront processing, which allows concurrent processing of coding units within different rows of a frame. While some video coding standards include wavefront parallel processing features, other standards lack standardized support for effectively integrating multiple parallelization techniques, such as combining tiling with wavefront processing.

Entropy coding represents a critical compression technique that compresses sequences by modeling the probability distribution of syntax elements. An efficient entropy coding algorithm generates codes whose length approaches the fundamental entropy of the original sequence. The precision of probability estimation directly impacts the compression performance, making it a crucial aspect of video encoding technologies.

In conventional video coding systems that implement wavefront parallel processing, maintaining accurate probability models for entropy coding remains a challenge. Traditional approaches often rely on simplistic techniques, such as using the same initial probability model for each row in wavefront processing, which can limit compression efficiency. These systems typically either globally reset or minimally update cumulative distribution functions (CDFs), resulting in poor adaptation to local data variations and inconsistent entropy coding across parallel processing units. This results in inefficiencies in entropy coding, especially when processing complex or high-resolution content.

Implementations of this disclosure address these challenges by introducing an advanced parallel processing methodology for video coding that enables sophisticated multi-threaded frame processing with improved probability model management. Implementations can include dividing a tile or frame into multiple wavefront groups in a horizontal direction, where each group includes a specific number of consecutive coding unit rows, with each wavefront comprising one or more LCU rows extending across the width of the tile. For instance, a tile might be organized into wavefront groups where rows 0 to N-1 form the first wavefront group, rows N to 2N-1 form the second wavefront group, and so on, with each group containing N coding unit rows. Each group of rows is numbered (aN+b) where a and b are constants, where a represents the wavefront group number and b represents the row within the wavefront group and b is in the range [0, N-1].

The teachings herein improve upon existing video encoding approaches by providing a flexible framework for wavefront group configuration and probability model management. Disclosed herein are approaches to initializing and updating Cumulative Distribution Function (CDF) models used in entropy coding across these wavefront groups. For example, the first coding unit row of each wavefront group could be initialized using a specific strategy, such as using the final CDF model state from the last row of the previous wavefront group or resetting to initial frame-level probability models.

Alternative implementations include multiple strategies for CDF model update and propagation. These strategies provide mechanisms for initializing CDF models at the start of each wavefront group, maintaining continuity of probability models across wavefront group boundaries, and selecting and combining CDF models from different wavefront groups after tile processing.

The number of wavefront groups can be determined based on available computational resources, such as the number of processing threads supported by the system. The wavefront configuration information, such as the number of wavefronts, their size, and processing delay, can be determined by the encoder and signaled in the bitstream through sequence headers or frame headers.

The disclosed techniques introduce dynamic and adaptive CDF updates synchronized with adjacent wavefront groups, allowing the probability models to better capture localized variations in video content. This adaptive synchronization leads to more accurate probability estimations, improving entropy coding efficiency and overall encoding performance. This approach can improve both compression efficiency and processing speed compared to conventional approaches. Notably, when wavefront processing is enabled, encoders and decoders may still maintain the option to process the tile in a normal raster scan order, provided that the entropy model updates are handled according to the specification.

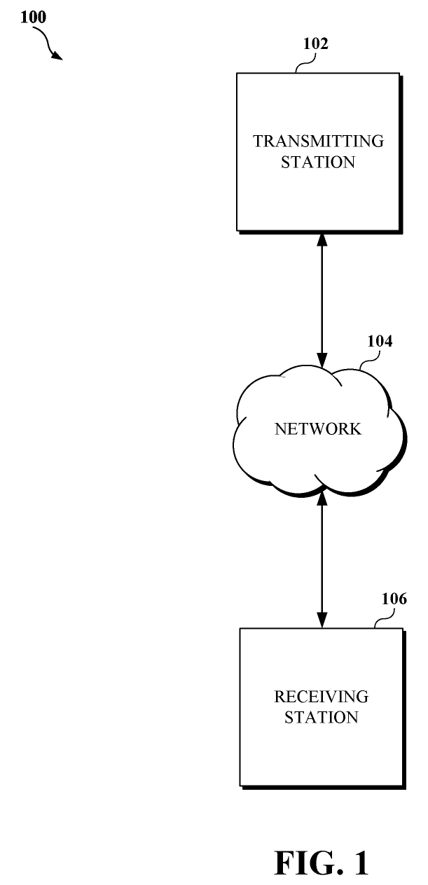

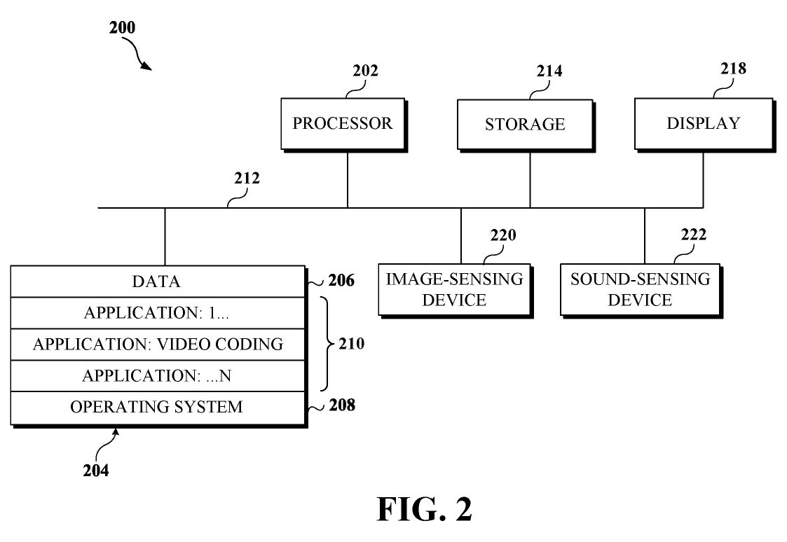

Further details of techniques for wavefront parallel processing with probability updates are described herein with initial reference to a system in which they can be implemented. FIG. 1 is a schematic of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used (e.g., a Hypertext Transfer Protocol-based (HTTP-based) video streaming protocol).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include a video coding application that performs the techniques described herein. The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

In some implementations, the code and data 206, the operating system 208, and the application programs 210 may be stored on a non-transitory computer-readable storage medium. The term "non-transitory" excludes transitory signals and refers to media such as hard drives, flash memory, ROM, and other physical storage devices capable of storing executable instructions. Such a non-transitory computer-readable storage medium may contain instructions that, when executed by the processor 202, cause the computing device 200 to perform any of the methods, techniques, or processes described herein. The secondary storage 214 is a non-transitory computer-readable storage medium that can store code and data, including machine-readable instructions that, when executed by the processor 202, cause the computing device 200 to perform one or more of the methods, techniques, or processes described herein. Additionally, a non-transitory computer-readable storage medium may store an encoded bitstream comprising encoded video data and associated signaling information.

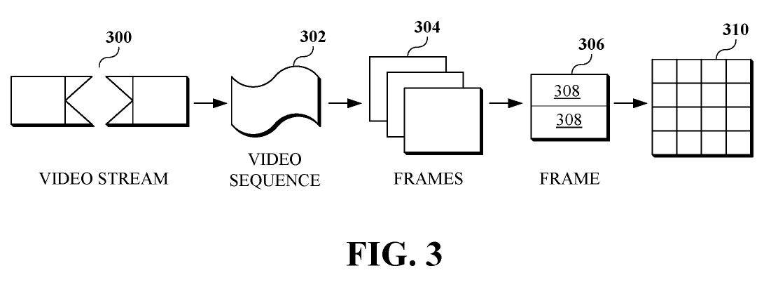

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16x16 pixels in the frame 306. The blocks 310 can also be arranged to include data from one or more segments 308 of pixel data. The blocks 310 can also be of any other suitable size such as 4x4 pixels, 8x8 pixels, 16x8 pixels, 8x16 pixels, 16x16 pixels, or larger. Unless otherwise noted, the terms block and macroblock are used interchangeably herein.

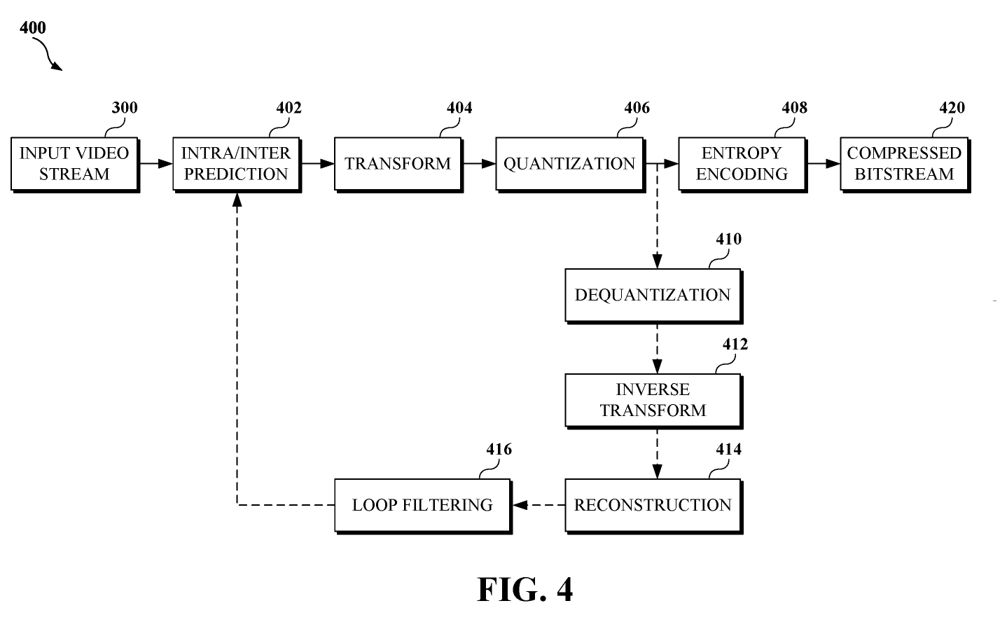

FIG. 4 is a block diagram of an encoder 400 according to implementations of this disclosure. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

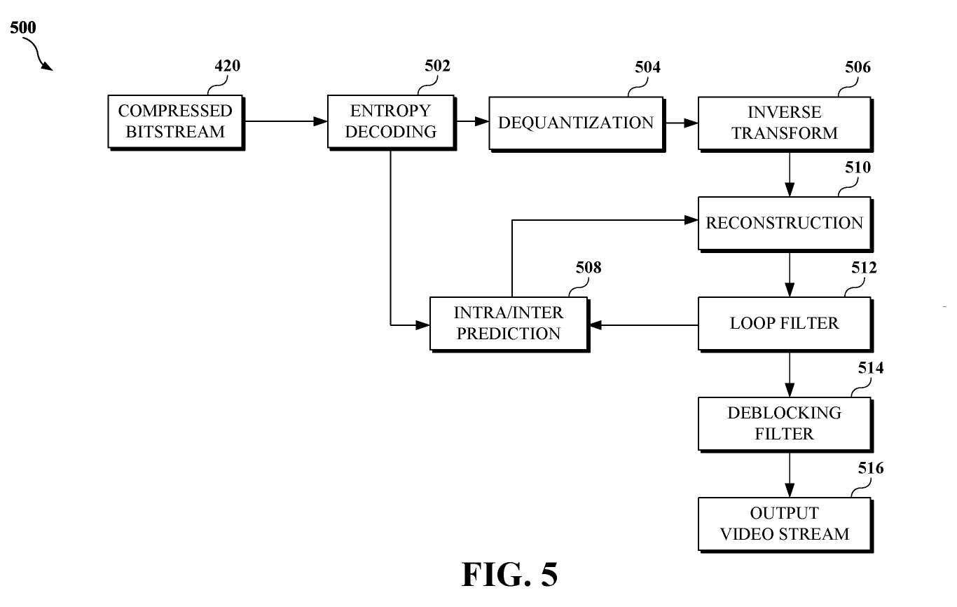

The reconstruction path (shown by the dotted connection lines) can be used so that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. In some implementations, the decoder 500 can produce the output video stream 516 without the deblocking filtering stage 514.

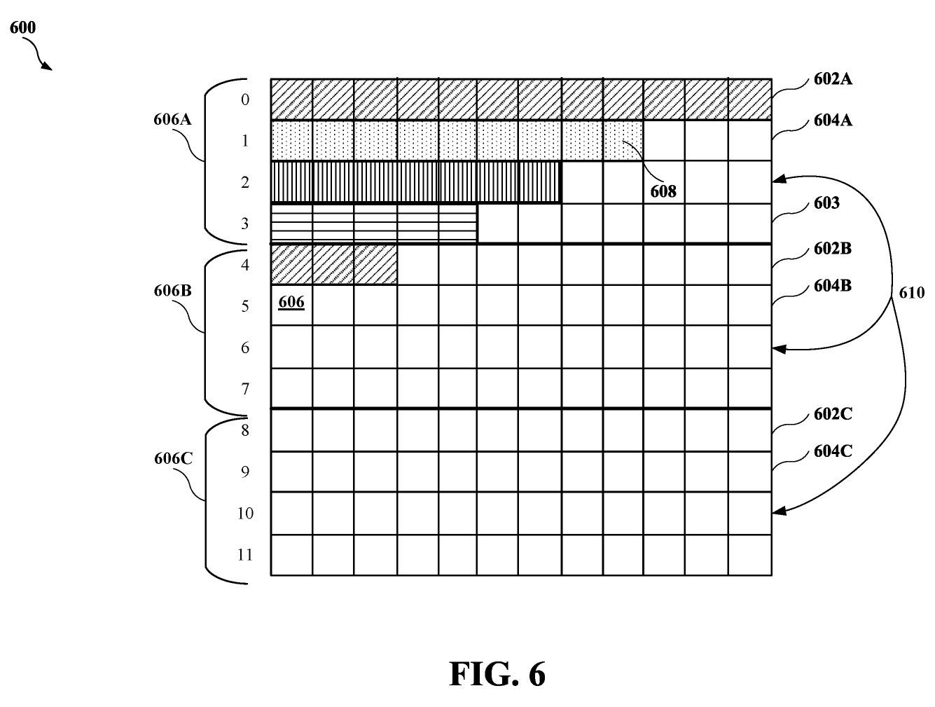

FIG. 6 illustrates an example of a tile 600 being processed using wavefront parallel processing. The tile 600 can be divided into wavefronts in a horizontal direction, where each wavefront includes one or more LCU rows extending across the width of the tile. The tile 600 is divided into multiple LCU rows, including LCU rows 602A-602C (i.e., 602A, 602B, and 602C) and 604A-604C (i.e., 604A, 604B, and 604C), where each LCU row comprises a row of largest coding units (LCUs) such as LCU 608 and LCU 606.

In this example, the tile 600 is configured with four wavefronts, where each wavefront processes LCU rows at regular intervals. Specifically, rows 0, 4, and 8 belong to a first wavefront, rows 1, 5, and 9 belong to a second wavefront, rows 2, 6, and 10 belong to a third wavefront (e.g., a wavefront 610), and rows 3, 7, and 11 belong to a fourth wavefront. The LCU rows are further organized into wavefront groups 606A, 606B, and 606C, where each wavefront group comprises four consecutive LCU rows. For instance, wavefront group 606A includes rows 0-3, wavefront group 606B includes rows 4-7, and wavefront group 606C includes rows 8-11.

The filled (hatched, dotted, and lined) LCUs in FIG. 6 indicate blocks that have been coded (e.g., encoded by an encoder, such as the encoder 400 of FIG. 4, or decoded by a decoder, such as the decoder 500 of FIG. 5), while empty blocks have not yet started coding. In this context, that a block has been encoded, can mean that the block has been encoded and reconstructed, as described with respect to FIG. 4; and that a block has been decoded, can mean that block has been reconstructed at the decoder. Each wavefront can be processed by a separate thread or core of a processing system, enabling parallel processing of multiple LCU rows. In a multi-core processor system, each processor core may be responsible for coding one wavefront, with the workload being allocated between cores as evenly as possible. Since multi-core processors typically have shared memory space, each core can efficiently share data with other cores coding other wavefronts. The number of wavefronts can be determined based on the available system resources - for instance, if the system supports two processing threads, then two wavefronts would be configured; if the system has multi-core or multi-thread processors that can support additional parallel processing, more wavefronts can be configured accordingly. This configuration represents a trade-off between processing speed and compression performance, as having more wavefronts generally results in faster processing but may slightly impact compression efficiency. To maintain coding dependencies, a predetermined delay is implemented between adjacent wavefronts within a wavefront group and between subsequent wavefront groups, with each wavefront being processed independently by its assigned thread or core.

As shown in FIG. 6, all LCUs of LCU row 602A have been coded, and sufficient LCUs of LCU row 603 (which belongs to a different wavefront) have also been coded to maintain dependencies. This has allowed coding to begin on LCU row 602B, as indicated by the partially filled blocks. In contrast, coding of blocks in LCU row 604B, such as LCU 606, has not yet commenced. This is because the thread or core responsible for that wavefront is still processing LCU row 604A, and therefore cannot begin processing of the LCU row 604B until the current processing is complete, even though the dependency requirements might be satisfied.

A Largest Coding Unit (LCU) represents the largest block unit used for video coding, which can be configured at the video sequence level to be 64×64, 128×128, 256×256 pixels, or another suitable size. Each LCU can be recursively partitioned into smaller Coding Units (CUs) using a quad-tree structure during the coding process. For example, a 128×128 LCU may be split into four 64×64 CUs, and each 64×64 CU may be further split into four 32×32 CUs, continuing down to smaller CU sizes based on the coding decisions signaled in the bitstream. Each CU contains both luma (brightness) and chroma (color) components of the video data. The coding of an LCU typically proceeds in a hierarchical manner, where the coder first determines the quad-tree partition structure for the LCU, then processes each resulting CU in a raster scan order (from left to right, top to bottom) within the LCU, applying the appropriate prediction and reconstruction operations based on the coding modes and parameters signaled in the bitstream. The quad-tree partition structure can be determined at the encoder and encoded in the compressed bitstream using one or more syntax elements, which the decoder uses to determine the quad-tree partition structure.

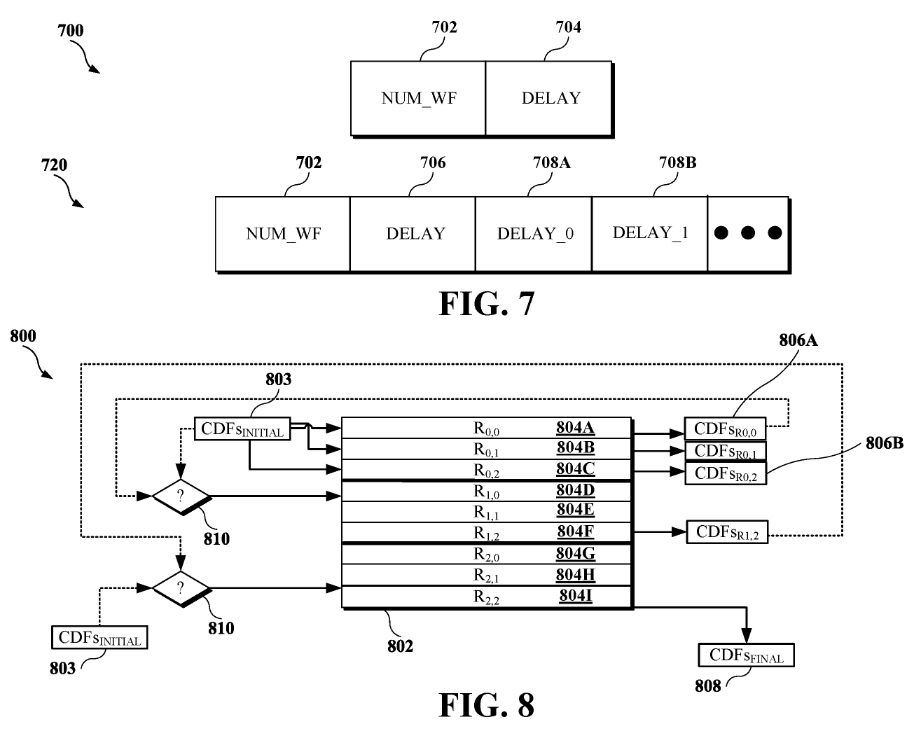

FIG. 7 illustrates examples 700 and 720 of portions of compressed bitstreams that include wavefront configuration information. The wavefront configuration information can be encoded in the compressed bitstream, which may be the compressed bitstream 420 of FIG. 4, by an encoder, such as the encoder 400 of FIG. 4. The wavefront configuration information can be used by a decoder, such as the decoder 500 of FIG. 5 for decoding the compressed bitstream.

The wavefront configuration information can be associated with a tile. As such, the wavefront configuration information can be encoded in a header associated with the tile (i.e., a tile header). Tiles are rectangular regions of a video frame that can be processed independently, enabling parallel processing and providing flexible access to different parts of the frame. Each tile can be coded independently of other tiles, which is particularly useful for parallel processing and reduced memory bandwidth requirements. In some examples, the same wavefront configuration information may generally apply to all tiles within a frame. As such, the wavefront configuration information may be encoded in the frame header. In some examples, the same wavefront configuration information may generally apply to all tiles of all frames of a video sequence. As such, the wavefront configuration information may be encoded in the sequence header. The wavefront configuration information may be encoded hierarchically, where sequence-level parameters provide default values, frame-level parameters can override sequence defaults, and tile-level parameters can override frame-level settings, allowing for adaptive configuration based on specific coding requirements.

In the example 700, the wavefront configuration information includes a NUM_WF syntax element 702 indicating the number of wavefronts and may include a DELAY syntax element 704 indicating the processing delay between consecutive LCU rows. The DELAY syntax element 704 specifies the minimum number of LCUs that are to be processed in one row before processing of the next row can begin, facilitating proper handling of coding dependencies. If a fixed delay is used, such as according to a video coding specification, the DELAY syntax element 704 may be omitted.

In an example, if a value of 0 is signaled for DELAY, the decoder determines the appropriate delay by examining context dependencies between LCU rows. The decoder calculates the minimum required delay based on the position of the rightmost LCU needed for context relative to the current LCU being processed. For example, if a current LCU at position (r+1, c) requires context from LCUs at positions (r, c-1), (r, c), and (r, c+1) in the row above it, the minimum delay would be 1 LCU. However, if the current LCU requires context from additional LCUs such as (r, c+2) or (r, c+3), the minimum delay would be 2 or 3 LCUs respectively, so that all necessary context information is available before processing begins.

In the example 720, the wavefront configuration information includes the NUM_WF syntax element 702, a DELAY syntax element 706, and one or more DELAY_i syntax elements 708A, 708B. While the example 720 shows two DELAY_i syntax elements, implementations may include more or fewer DELAY_i syntax elements depending on the number of wavefront groups.

The DELAY syntax element 706 indicates the processing delay between wavefronts (LCU rows) within a same wavefront group. The one or more DELAY_i syntax elements 708A, 708B indicate the delays between wavefront groups, where i represents the index of the wavefront group boundary. For example, DELAY_0 indicates the delay between wavefront group 1 and wavefront group 2. This more flexible configuration allows for different delays between different wavefront groups, enabling optimization based on the specific characteristics of the video content and available processing resources.

The encoder may determine appropriate delay values by considering dependencies introduced by various coding tools. For intra prediction, the delay is to account for references to pixels from above LCUs used for prediction modes, while for loop filtering, the delay can facilitate ensuring sufficient neighboring LCUs are reconstructed before filter operations can be applied. Additionally, context abstraction for entropy coding may require information from previously coded LCUs in the row above, so the encoder sets delay values that satisfy the maximum dependency distance required by any of these coding tools.

FIG. 8 is an example 800 illustrating probability updates with wavefront parallel processing. The example includes a tile 802 having multiple LCU rows 804A-804I organized into wavefront groups. While FIG. 8 shows nine LCU rows and three wavefront groups for illustration, tile 802 may include additional LCU rows and more or fewer wavefront groups. The LCU rows are indexed using the notation R_{i,j}, where i indicates the wavefront group number and j indicates the wavefront number within the group.

In this example, the LCU rows are organized into three wavefront groups, with three rows per group. The first wavefront group includes LCU rows 804A, 804B, 804C. The second wavefront group includes LCU rows 804D, 804E, and 804F. The third wavefront group includes LCU rows 804G, 804H, and 804I. Within each group, rows having the same j index belong to the same wavefront - for example, rows R_{0,0}, R_{1,0}, and R_{2,0} belong to wavefront 0.

Initial CDFs 803 represent frame-level initial probability models. These frame-level initial values are derived from probability statistics of previously coded frames and serve as starting probability models for entropy coding of a current frame, which includes the tile 802. For the first frame of a video sequence, the initial CDFs 803 may be preset to default values. For a later frame of the video sequence, the initial CDFs 803 may be derived from one or more of: the final CDFs of the previous frame, an average of final CDFs across multiple tiles of the previous frame, or the final CDFs from a specifically selected tile of the previous frame, where the selection may be indicated in the compressed bitstream, as further described herein.

The CDF updates flow from left to right in the diagram, with updated CDFs (such as updated CDFs 806A and 806B) being generated as each LCU row is processed. Different implementations may use different strategies for initializing CDF models for at least some of the LCU rows. Decision points 810 represent a selection between initialization strategies. In a first implementation, when processing any LCU row, the CDF model is reset to the frame initial values (the initial CDFs 803). In a second implementation, when processing an LCU row in wavefront group (i+1), the CDF model is initialized using the final CDF values from the corresponding row (same j index) in wavefront group i.

To illustrate the second implementation, when processing row R_{1,0}, the CDF model would be initialized using the final CDF values from processing row R_{0,0}, thereby maintaining separate CDF model updates across rows of the same wavefront. In another implementation, which strategy to use may be indicated in the bitstream. For example, the wavefront configuration information may include one or more syntax elements indicating which initial CDFs to use.

Final CDFs 808 represent the probability models after processing the entire tile. Different implementations are possible for selecting the final CDFs 808. In a first implementation, the final CDFs 808 are copied from either the first or last wavefront of the tile. In a second implementation, the final CDFs 808 are copied from a particular wavefront of the tile, where the index of that wavefront is signaled in the bitstream. In a third implementation, the final CDFs 808 are derived by averaging the CDFs across all wavefronts of the tile. In some implementations, the wavefront configuration information may include one or more syntax elements indicating how the final CDFs 808 are selected. In some implementations, the selection of the final CDFs 808 may be pre-configured in the codec.

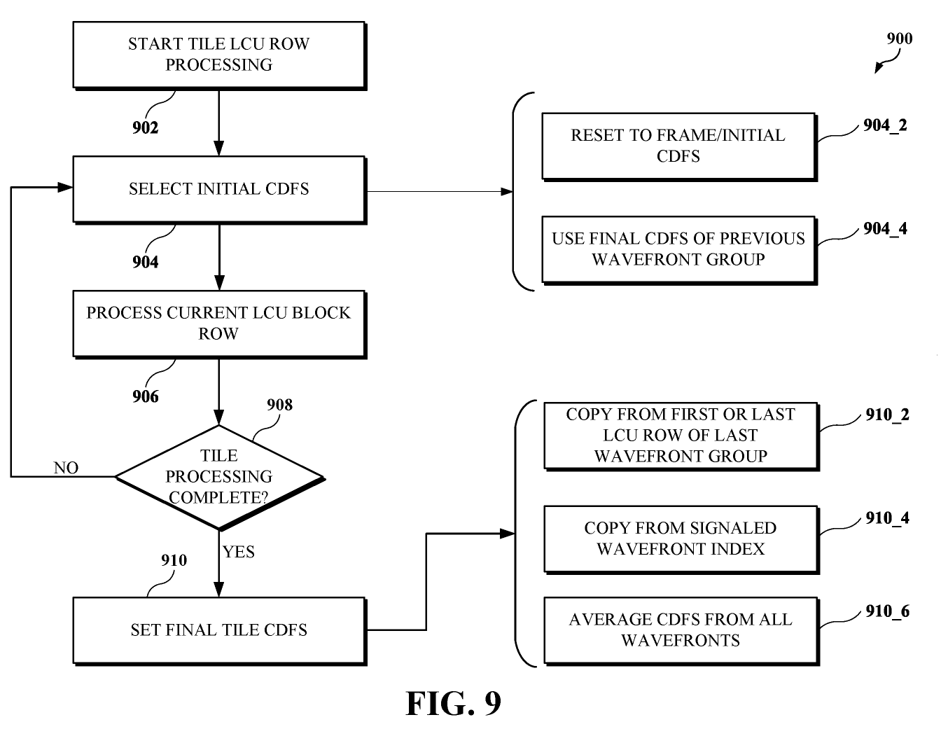

FIG. 9 is an example of a flowchart of a technique 900 for selecting initial CDFs prior to processing LCU rows of a tile and for setting final CDFs after processing all LCU rows of the tile. The technique 900 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as the processor 202, may cause the computing device to perform the technique 900.

The technique 900 may be implemented in whole or in part in the entropy encoding stage 408 of the encoder 400 of FIG. 4 and/or the entropy decoding stage 502 of the decoder 500 of FIG. 5. When implemented by an encoder, “coding” means “encoding,” as described with respect to FIG. 4; and when implemented by a decoder, “coding” means “decoding,” as described with respect to FIG. 5. The technique 900 can be implemented using specialized hardware or firmware. Multiple processors, memories, or both, may be used.

At 902, the technique 900 starts tile LCU row processing. Starting tile LCU row processing can include receiving or accessing a tile of a current frame for coding and determining that the tile includes one or more LCU rows to be processed. Starting tile LCU row processing can further include initializing data structures for tracking CDF states across wavefront groups.

At 904, the technique 900 selects initial CDFs for processing a current LCU row. This selection can be implemented in different ways. With respect to any LCU row (e.g., any of LCU rows 804A through 804C of FIG. 8) of the first wavefront group, the technique 900 selects the frame initial CDFs. For subsequent wavefront groups, in a first implementation shown at 904_2, the technique 900 resets to frame initial CDFs. In a second implementation shown at 904_4, the technique 900 uses the final CDFs from the same wavefront as the LCU row of the previous wavefront group. Which of the first or second implementation to use may be indicated in a compressed bitstream. That is, the encoder signals, via one or more syntax elements, the selection strategy that the decoder is to use.

At 906, the technique 900 processes the current LCU block row using the selected initial CDFs. While not specifically shown in FIG. 9, as the blocks of the current LCU row are processed, the CDFs are updated. At 908, the technique 900 determines whether tile processing is complete (i.e., whether there are more LCU row blocks to process). If tile processing is not complete ("NO" path), the technique 900 returns to 904 to select initial CDFs for the next LCU row.

At 910, if tile processing is complete ("YES" path), the technique 900 sets the final tile CDFs. This can be implemented in different ways. In a first implementation shown at 910_2, the technique copies CDFs from the first or last LCU row of the one of wavefront groups (e.g., the first or last wavefront group of the tile). In a second implementation shown at 910_4, the technique 900 copies CDFs from a wavefront index that is signaled (encoded by the encoder and read by the decoder) in the compressed bitstream. In a third implementation shown at 910_6, the technique averages CDFs from all wavefronts.

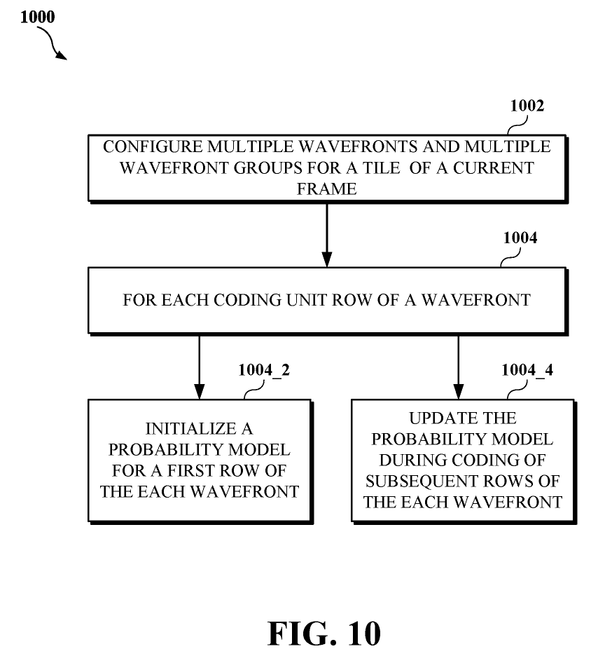

FIG. 10 is an example of a flowchart of a technique 1000 for selecting initial probability models prior to processing coding unit rows of a tile and for setting final probability models after processing all coding unit rows of the tile. The technique 1000 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as the processor 202, may cause the computing device to perform the technique 1000. The technique 1000 may be implemented in whole or in part in the entropy encoding stage 408 of the encoder 400 of FIG. 4 and/or the entropy decoding stage 502 of the decoder 500 of FIG. 5. When implemented by an encoder, “coding” means “encoding,” as described with respect to FIG. 4; and when implemented by a decoder, “coding” means “decoding,” as described with respect to FIG. 5. The technique 1000 can be implemented using specialized hardware or firmware. Multiple processors, memories, or both, may be used.

At 1002, the technique 1000 begins by configuring multiple wavefronts and multiple wavefront groups for a tile of a current frame. The tile can be one of multiple tiles of the current frame. In some examples, the current frame may include only one tile. The tile can be divided into the multiple wavefronts in a horizontal direction. The tile can be one of multiple tiles of the current frame. Each wavefront group includes consecutive coding unit rows, and each wavefront includes coding unit rows. The coding unit rows can be LCU rows. The coding unit rows can be selected at regular intervals across the tile such that corresponding rows across wavefront groups belong to the same wavefront. In other words, an n^{th} row of each wavefront group belongs to an n^{th} wavefront.

The number of wavefronts may be determined based on the available processing threads of the video coding computing device, facilitating optimized resource utilization. For example, a tile may be configured with two to eight wavefronts, though other configurations are possible. The regular intervals for wavefront selection can be calculated based on both the total number of coding unit rows in the tile and the number of configured wavefronts. For example, each wavefront group comprises N consecutive LCU rows, numbered from 0 to N-1, where rows with the same number across different wavefront groups belong to the same wavefront.

In an example, the technique 1000 may encode/decode wavefront configuration information in/from a compressed bitstream. That is, the technique 1000 may code wavefront configuration information included in a compressed bitstream. This wavefront configuration information may include parameters such as the number of wavefronts, wavefront size (e.g., indicating the size of LCUs, or more generally coding units, such as 64×64, 128×128, or 256×256 pixels), and processing delay between adjacent wavefronts. The technique 1000 may include determining a minimum delay between adjacent wavefronts based on coding unit (e.g., LCU) dependencies and configuring the wavefront processing accordingly. Each wavefront (n) is processed with a predetermined delay relative to its adjacent wavefront (n-1) to maintain proper dependencies within a wavefront group, and additionally, the first wavefront of each wavefront group (i) is processed with a delay relative to the last wavefront of the previous wavefront group (i-1) to maintain dependencies across wavefront groups.

At 1004, the technique 1000 iterates over the coding unit rows of each wavefront. For a first coding unit row of a wavefront, the technique 1000 performs step 1004_2. For subsequent coding unit rows of the wavefront, the technique 1000 performs step 1004_4. For initializing probability models at step 1004_2, the technique 1000 can use frame-level initial probability values. For wavefront groups after the first wavefront group (i.e., for wavefront group N, where N>0), the technique 1000 can alternatively copy the finishing probability values from a last row of the wavefront in the previous wavefront group. The probability model can be a CDF.

At step 1004_4, the technique 1000 initializes the probability model for subsequent coding unit rows of the wavefront using the finishing probability values from the previous coding unit row of the same wavefront, and updates the probability model during coding of each subsequent row. More accurately, the probability model may be updated as blocks of the coding unit row are being coded. As such, as processing of coding unit rows within the same wavefront proceeds, the probability model associated with that wavefront is updated. Said another way, each wavefront is associated with its own separate probability model that gets updated based on symbol occurrences during the coding of coding unit rows of the wavefront and the probability model is updated during the coding of subsequent rows within the same wavefront using finishing probability values from the previous row.

The technique 1000 may include maintaining dependencies between adjacent wavefronts for operations including intra prediction, loop filtering, and context abstraction. The tile can be processed in a raster scan order while maintaining these probability model updates according to the wavefront configuration information.

The technique 1000 may include combining probability models from different wavefronts to generate an updated tile-level probability model. Upon completing the coding of the entire tile, the technique 1000 may determine a final tile-level probability model based on the probability models from one (e.g., the first or the last wavefront) or more wavefronts. This final tile-level probability model can be determined in several ways: by selecting finishing probability values from one of the multiple wavefronts of the tile, by averaging respective finishing probability values across all wavefronts of the tile, or by selecting finishing probability values from a specific wavefront that is explicitly indicated in the bitstream.

For simplicity of explanation, the techniques 900 and 1000 of FIGS. 9 and 10, respectively, are each depicted and described as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such.

Implementations of the transmitting station 102 and/or the receiving station 106 (and the algorithms, processes, methods, instructions, techniques, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, techniques, processes, and/or instructions described herein. In addition, or alternatively, for example, a special purpose computer/processor can be utilized which can contain other hardware for carrying out any of the methods, techniques, processes, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described embodiments, implementations, and aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method, comprising:
configuring multiple wavefronts and multiple wavefront groups for a tile of a current frame,
wherein each wavefront group of the multiple wavefront groups comprises a set of consecutive coding unit rows, and
wherein each wavefront of the multiple wavefronts comprises coding unit rows selected at intervals across the tile such that an n^{th} row of each of the multiple wavefront groups belongs to an n^{th} wavefront; and
for each wavefront of at least some of the multiple wavefronts:
initializing a probability model for a first row of the wavefront; and
updating the probability model during coding of subsequent rows of the wavefront using finishing probability values from a previous row of the wavefront.

2. The method of claim 1, further comprising:
coding wavefront configuration information included in a compressed bitstream, the wavefront configuration information comprising at least one of: a number of the multiple wavefronts, a wavefront size, or a processing delay between adjacent wavefronts.

3. The method of claim 1, further comprising:
combining probability models from different wavefronts after completing processing of the tile to generate an updated tile-level probability model.

4. The method of claim 1, wherein configuring the multiple wavefronts comprises:
determining a number of the multiple wavefronts based on available processing threads of a video coding system.

5. The method of claim 1, wherein the intervals are determined based on a number of the coding unit rows in the tile and a number of configured wavefronts.

6. The method of claim 1, further comprising:
after completing coding of the tile, determining a final tile-level probability model based on probability models from one or more of the wavefronts.

7. The method of claim 6, wherein determining the final tile-level probability model comprises:
selecting finishing probability values from one of the multiple wavefronts of the tile.

8. The method of claim 6, wherein determining the final tile-level probability model comprises:
averaging respective finishing probability values across the multiple wavefronts of the tile.

9. The method of claim 6, wherein determining the final tile-level probability model comprises:
selecting finishing probability values from a specific wavefront indicated in a bitstream.

10. The method of claim 6, wherein determining the final tile-level probability model comprises:
selecting finishing probability values from a first wavefront or a last wavefront of the tile.

11. A device, comprising:
a processor configured to execute instructions to:
configure multiple wavefronts and multiple wavefront groups for a tile of a current frame,
wherein each wavefront group of the multiple wavefront groups comprises a set of consecutive coding unit rows, and
wherein each wavefront of the multiple wavefronts comprises coding unit rows selected at intervals across the tile such that an n^{th} row of each of the multiple wavefront groups belongs to an n^{th} wavefront; and
for each wavefront of at least some of the multiple wavefronts:
initialize a probability model for a first row of the wavefront; and
update the probability model during coding of subsequent rows of the wavefront using finishing probability values from a previous row of the wavefront.

12. The device of claim 11, the processor further configured to:
maintain dependencies between adjacent wavefronts for at least one of: intra prediction, loop filtering, or context abstraction.

13. The device of claim 11, the processor further configured to:
process the tile in a raster scan order while maintaining the probability model updates according to wavefront configuration information.

14. The device of claim 11, wherein the wavefront is processed with a predetermined delay relative to an adjacent wavefront.

15. The device of claim 11, the processor further configured to:
determine a minimum delay between adjacent wavefronts based on dependencies amongst the coding unit rows; and configure wavefront processing based on the determined minimum delay.

16. The device of claim 11, wherein, to initialize the probability model for the first row of the wavefront, the processor is configured to:
use frame-level initial probability values.

17. The device of claim 11, wherein, for a wavefront group after a first wavefront group, to initialize the probability model for the first row of the wavefront, the processor is configured to:
copy finishing probability values from a last row of the wavefront in a previous wavefront group.

18. A non-transitory computer-readable storage medium storing an encoded bitstream for decoding by a processor, the encoded bitstream comprising:
encoded video data corresponding to a tile of a current frame; and
wavefront configuration information for the tile, the wavefront configuration information comprising at least one of:
a number of multiple wavefronts,
a wavefront size, or
a processing delay between adjacent wavefronts.

19. The non-transitory computer-readable storage medium of claim 18, wherein the wavefront configuration information is included in at least one of: a sequence header, a frame header, or a tile header.

20. The non-transitory computer-readable storage medium of claim 18, wherein the wavefront configuration information further comprises:
an indication of a specific wavefront from which to select finishing probability values for determining a final tile-level probability model.
